(19) United States
(12) Patent Application Publication
(10) Pub. No.: US 2026/0172914 A1
(43) Pub. Date: Jun. 18, 2026

(54) COMBINATION EVENT CONFIGURATION METHOD, TERMINAL, AND NETWORK SIDE DEVICE

(71) Applicant: VIVO MOBILE COMMUNICATION CO., LTD., Dongguan (CN)

(72) Inventors: Zhihan HUANG, Dongguan (CN); Wenjuan PU, Dongguan (CN); Xiaodong YANG, Dongguan (CN)

(21) Appl. No.: 19/533,327

(22) Filed: Feb. 9, 2026

Related U.S. Application Data
(63) Continuation of application No. PCT/CN2024/110156, filed on Aug. 6, 2024.

(30) Foreign Application Priority Data
Aug. 11, 2023 (CN) 202311018844.4

(51) Int. Cl. H04W 36/00; H04W 24/10

(52) U.S. Cl. CPC H04W 36/0058; H04W 24/10

(57) ABSTRACT

A combination event configuration method, a terminal, and a network side device are provided. The combination event configuration method includes: receiving, by a terminal, first configuration information sent by a network side device, where the first configuration information is used to indicate a configuration of a combination event by the network side device; and performing, by the terminal, measurement, and determining, based on the first configuration information and whether an entering condition or a leaving condition of the combination event is met in a measurement process, whether to perform measurement reporting, where the combination event is an event formed by combining a first event and a second event, the first event is a terminal height-dependent event, and the second event is a mobility management-dependent event.

### CROSS-REFERENCE TO RELATED APPLICATIONS

This application is a continuation of International Patent Application No. PCT/CN2024/110156, filed on Aug. 6, 2024, which claims priority to Chinese Patent No. 202311018844.4, filed in China on Aug. 11, 2023, both of which are incorporated herein by reference in their entireties.

### TECHNICAL FIELD

This application pertains to the field of communication technologies, and specifically relates to a combination event configuration method, a terminal, and a network side device.

### BACKGROUND

When a terminal is in flight, a flight height of the terminal has more LOS (Line of sight, line of sight) paths than those of a terrestrial terminal, leading to severe downlink interference. That is, downlink signals sent by a plurality of neighboring cells are received, and significant interference on the neighboring cells is caused when uplink signals are sent.

### SUMMARY

Embodiments of this application provide a combination event configuration method, a terminal, and a network side device.

According to a first aspect, a combination event configuration method is provided and is executed by a terminal. The method includes: receiving, by a terminal, first configuration information sent by a network side device, where the first configuration information is used to indicate a configuration of a combination event by the network side device; and performing, by the terminal, measurement, and determining, based on the first configuration information and whether an entering condition or a leaving condition of the combination event is met in a measurement process, whether to perform measurement reporting, where the combination event is an event formed by combining a first event and a second event, the first event is a terminal height-dependent event, and the second event is a mobility management-dependent event.

According to a second aspect, a combination event configuration method is provided and is executed by a network side device. The method includes: sending, by a network side device, first configuration information to a terminal, where the first configuration information is used to indicate a configuration of a combination event by the network side device; and the combination event is an event formed by combining a first event and a second event, the first event is a terminal height-dependent event, and the second event is a mobility management-dependent event.

According to a third aspect, a combination event configuration apparatus is provided, including: a first receiving unit, configured to receive first configuration information sent by a network side device, where the first configuration information is used to indicate a configuration of a combination event by the network side device; and a first determining unit, configured to: perform measurement, and determine, based on the first configuration information and whether an entering condition or a leaving condition of the combination event is met in a measurement process, whether to perform measurement reporting, where the combination event is an event formed by combining a first event and a second event, the first event is a terminal height-dependent event, and the second event is a mobility management-dependent event.

According to a fourth aspect, a combination event configuration apparatus is provided, including: a first sending unit, configured to send first configuration information to a terminal, where the first configuration information is used to indicate a configuration of a combination event by the network side device; and the combination event is an event formed by combining a first event and a second event, the first event is a terminal height-dependent event, and the second event is a mobility management-dependent event.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface. The communication interface is configured to receive first configuration information sent by a network side device, where the first configuration information is used to indicate a configuration of a combination event by the network side device; and the processor is configured to: perform measurement, and determine, based on the first configuration information and whether an entering condition or a leaving condition of the combination event is met in a measurement process, whether to perform measurement reporting, where the combination event is an event formed by combining a first event and a second event, the first event is a terminal height-dependent event, and the second event is a mobility management-dependent event.

According to a seventh aspect, a network side device is provided. The network side device includes a processor and a memory, the memory stores a program or an instruction that can be run on the processor, and the program or the instruction is executed by the processor to implement the steps of the method according to the second aspect.

According to an eighth aspect, a network side device is provided, including a processor and a communication interface. The communication interface is configured to send first configuration information to a terminal, where the first configuration information is used to indicate a configuration of a combination event by the network side device; and the combination event is an event formed by combining a first event and a second event, the first event is a terminal height-dependent event, and the second event is a mobility management-dependent event.

According to a ninth aspect, a readable storage medium is provided. The readable storage medium stores a program or an instruction, and the program or the instruction is executed by a processor to implement the steps of the combination event configuration method according to the first aspect or the steps of the combination event configuration method according to the second aspect.

According to a tenth aspect, a wireless communication system is provided, including a terminal and a network side device. The terminal may be configured to perform the steps of the combination event configuration method according to the first aspect, and the network side device may be configured to perform the steps of the combination event configuration method according to the second aspect.

According to an eleventh aspect, a chip is provided. The chip includes a processor and a communication interface, the communication interface is coupled to the processor, and the processor is configured to run a program or an instruction to implement the combination event configuration method according to the first aspect or the combination event configuration method according to the second aspect.

According to a twelfth aspect, a computer program/program product is provided. The computer program/program product is stored in a storage medium, and the program/program product is executed by at least one processor to implement the steps of the combination event configuration method according to the first aspect or the steps of the combination event configuration method according to the second aspect.

In the embodiments of this application, first configuration information sent by a network side device is received, and a configuration of a combination event by the network side device is obtained, where the combination event is a combination event constituted by a terminal height-dependent event and a mobility management-dependent event. Then, the terminal performs measurement, and determines, based on whether an entering condition or a leaving condition of the combination event is met in a measurement process or whether the number of cells in a cell trigger list corresponding to the combination event meets a cell number threshold, whether to perform measurement reporting, so that measurement reporting can be performed only when a condition for measurement reporting is met.

### BRIEF DESCRIPTION OF DRAWINGS

FIG. 1 is a block diagram of a wireless communication system to which the embodiments of this application can be applied;

FIG. 2 is a first schematic flowchart of a combination event configuration method according to an embodiment of this application;

FIG. 3 is a second schematic flowchart of a combination event configuration method according to an embodiment of this application;

FIG. 4 is a first schematic structural diagram of a combination event configuration apparatus according to an embodiment of this application;

FIG. 5 is a second schematic structural diagram of a combination event configuration apparatus according to an embodiment of this application;

FIG. 6 is a schematic structural diagram of a communication device according to an embodiment of this application;

FIG. 7 is a schematic structural diagram of hardware of a terminal according to an embodiment of this application; and

FIG. 8 is a schematic structural diagram of hardware of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, “or” in this application means at least one of connected objects. For example, “A or B” covers three schemes. Scheme 1: including A but excluding B; Scheme 2:

including B but excluding A; Scheme 3: including both A and B. The character “/” generally indicates an “or” relationship between the associated objects.

The term “indication” in this application may be either a direct indication (or an explicit indication) or an indirect indication (or an implicit indication). A direct indication may be understood as that a sender explicitly informs a recipient of content such as specific information, an operation to be performed, or a requested result in a sent indication. An indirect indication may be understood as that a recipient determines corresponding information based on an indication sent by a sender, or makes a judgment and determines an operation to be performed or a requested result based on a judgment result.

It should be noted that technologies described in the embodiments of this application are not limited to a Long Term Evolution (Long Term Evolution, LTE)/LTE-Advanced (LTE-Advanced, LTE-A) system, and may further be applied to other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), single-carrier frequency division multiple access (Single-carrier Frequency Division Multiple Access, SC-FDMA), or other systems. The terms “system” and “network” in the embodiments of this application may be used interchangeably. The technologies described can be applied to both the systems and the radio technologies mentioned above as well as to other systems and radio technologies. The following describes a New Radio (New Radio, NR) system for example purposes, and NR terms are used in most of the following descriptions. These technologies can also be applied to systems other than the NR system, such as a 6th generation (6th Generation, 6G) communication system.

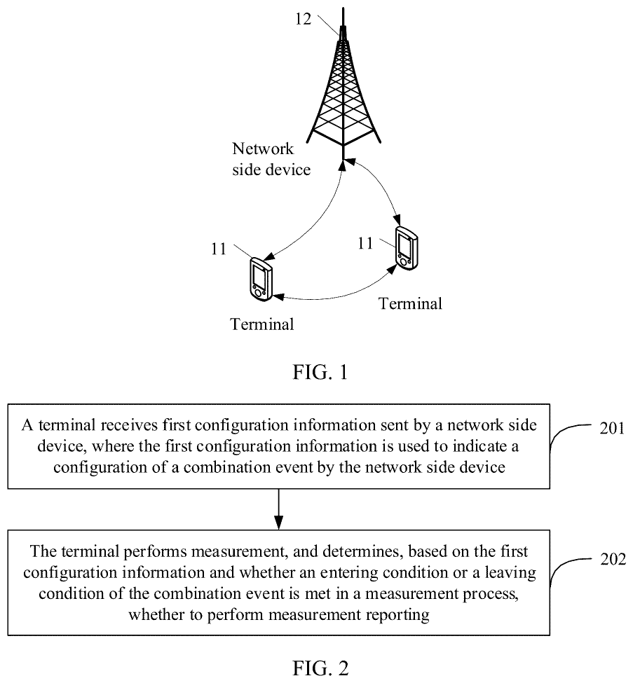

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), an augmented reality (Augmented Reality, AR) device, a virtual reality (Virtual Reality, VR) device, a robot, a wearable device (Wearable Device), a flight vehicle (flight vehicle), vehicle user equipment (Vehicle User Equipment, VUE), shipborne equipment, pedestrian user equipment (Pedestrian User Equipment, PUE), a smart home (a home device with a wireless communication function, such as a refrigerator, a television, a washing machine, or a furniture), a game console, a personal computer (Personal Computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. The vehicle user equipment may also be referred to as an in-vehicle terminal, an in-vehicle controller, an in-vehicle module, an in-vehicle component, an in-vehicle chip, or an in-vehicle unit. It should be noted that a specific type of the terminal 11 is not limited in the embodiments of this application. The network side device 12 may include an access network device or a core network device. The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AP), a wireless fidelity (Wireless Fidelity, WiFi) node, or the like. The base station may be referred to as a NodeB (NodeB, NB), an evolved NodeB (Evolved NodeB, eNB), a next generation NodeB (the next generation NodeB, gNB), a new radio NodeB (New Radio NodeB, NR NodeB), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home NodeB, HNB), a home evolved NodeB (home evolved NodeB), a transmission reception point (Transmission Reception Point, TRP), or another appropriate term in the field. As long as a same technical effect is achieved, the base station is not limited to a specified technical term. It should be noted that, in this application, only a base station in an NR system is used as an example, and a specific type of the base station is not limited.

The core network device may include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rule function unit (Policy and Charging Rules Function, PCRF), an edge application server discovery function (Edge Application Server Discovery Function, EASDF), unified data management (Unified Data Management, UDM), a unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF, or L-NEF), a binding support function (Binding Support Function, BSF), an application function (Application Function, AF), and the like. It should be noted that, in the embodiments of this application, only a core network device in an NR system is used as an example for description, and a specific type of the core network device is not limited.

With reference to the accompanying drawings, the following describes in detail a combination event configuration method, a terminal, and a network side device provided in the embodiments of this application by using some embodiments and application scenarios thereof.

FIG. 2 is a first schematic flowchart of a combination event configuration method according to an embodiment of this application. As shown in FIG. 2, the combination event configuration method includes step 201 and step 202.

Step 201: A terminal receives first configuration information sent by a network side device, where the first configuration information is used to indicate a configuration of a combination event by the network side device.

The combination event (Combination Event) is an event formed by combining a first event and a second event, the first event is a terminal height-dependent event, and the second event is a mobility management-dependent event.

Optionally, the terminal may be an unmanned aerial vehicle (Unmanned Aerial Vehicle, UAV), commonly known as a drone, an unmanned combat aircraft, or a micro drone, and broadly referred to as various remote-controlled aircraft that do not require a pilot. The following describes this application by using an example in which the terminal is a UAV. However, the terminal in this application is not limited thereto.

An interference problem of UAV UE is mainly caused by a high flight height. Therefore, terminal height-dependent events H1 and H2 are introduced in LTE, where the event H1 is that a height of the UE is greater than a configured height threshold 1, and H2 is that the height of the UE is less than a configured height threshold 2. When entering the event H1 or H2, the UE triggers reporting of a measurement result. The reported measurement result may include: a measurement result corresponding to a reporting measurement identity measID; the height of the UE; and location information to be reported by the UE if a network instructs the UE to report the location information.

It should be noted that, in addition to measuring intra-frequency and inter-frequency neighboring cells of a serving cell, the terminal in the network may need to measure inter-system neighboring cells. To simplify identification of neighboring cells in measurement and reporting processes, a measurement object (measurement object) is associated with a reporting configuration (reporting configuration), and the neighboring cell is identified by a measurement identity (measurement identity, measID). Each cell has a measurement identity list, and one measurement object in each measurement identity is associated with one measurement report. Through configuration of a plurality of measurement identities, a plurality of measurement objects may be linked to a same reporting configuration, or a plurality of reporting configurations may be linked to a same measurement object. A measurement result may be reference signal received power (Reference Signal Receiving Power, RSRP), reference signal received quality (reference signal received quality, RSRQ), a signal to interference plus noise ratio (Signal to Interference plus Noise Ratio, SINR) of a serving cell, or the like.

The network side device may perform a corresponding interference avoidance/resolution measure based on a measurement report reported by the terminal. When leaving the event H1 or H2, the terminal deletes a corresponding measurement result.

In a time period between entering and leaving the event H1/H2 by the terminal, the UE may continue to perform reporting based on a configured reporting interval and the number of reporting times.

An entering condition (Entering condition) and a leaving condition (leaving condition) of the event H1/H2 are as follows:

Condition of entering the event H1 (entering H1 in the case of being greater than a specified value): Ms−Hys>Thresh+Offset.

Condition of leaving the event H1 (leaving H1 in the case of being less than a specified value): Ms+Hys<Thresh+Offset.

Condition of entering the event H2 (entering H2 in the case of being less than a specified value): Ms+Hys<Thresh+Offset.

Condition of leaving the event H2 (leaving H2 in the case of being greater than a specified value): Ms−Hys>Thresh+Offset.

Ms is a measurement result; Hys is a hysteresis factor and is used to avoid a ping-pong effect caused by signal fluctuation; Thresh is a common height reference point of the events H1 and H2; and the network side device may configure different Hys and Offset for the events H1 and H2.

Optionally, the first event may be one terminal height-dependent event, or may be an event formed by combining a plurality of different height-dependent events.

In this embodiment of this application, the first event may be the event H1, or the event H2, or a combination of the events H1 and H2.

It should be noted that in this embodiment of this application, that an entering condition of the combination of the events H1 and H2 is met means that an entering condition of H1 and an entering condition of H2 are both met, and that a leaving condition of the combination of the events H1 and H2 is met means that a leaving condition of H1 or H2 is met.

In this embodiment of this application, the mobility management-dependent event includes an event A3/A4/A5 or an enhanced event A3/A4/A5. An entering condition and a leaving condition of the event A3/A4/A5 are as follows:

The event A3 indicates that a measurement result of a neighboring cell is better than a measurement result of a serving cell. The entering condition and the leaving condition of the event A3 are as follows:

$$\begin{matrix}Entering condition : Mn + O fn + Ocn - Hys > Mp + O f p + O c p + Off . \\ Leaving condition : Mn + Of n + O cn + Hys < Mp + O f p + O c p + Off .\end{matrix}$$

Mn is the measurement result of the neighboring cell, and Mp is the measurement result of the serving cell; Ofn and Ocn are offsets configured by a neighboring cell parameter (offsetMO), and Ofp and Ocp are offsets configured by a serving cell parameter (cellIndividualOffset); Off is an offset (a3-Offset) configured for the event A3; and Hys is a hysteresis factor.

The event A4 indicates that a measurement result of a neighboring cell exceeds a threshold. The entering condition and the leaving condition of the event A4 are as follows:

$$\begin{matrix}Entering condition : Mn + O fn + Ocn - Hys > Thresh . \\ Leaving condition : Mn + Of n + O cn + Hys < Thresh .\end{matrix}$$

Mn is the measurement result of the neighboring cell, and no offset is considered; Ofn is a specific offset of a measurement object of the neighboring cell (that is, offsetMO defined in measObjectNR corresponding to the neighboring cell); Ocn is a specific offset of a measurement object of the neighboring cell (that is, cellIndividualOffset defined in measObjectNR corresponding to the neighboring cell), and Ocn is set to zero in the case of not being configured for the neighboring cell; Hys is a hysteresis parameter of this event (hysteresis defined in reportConfigNR of this event); and Thresh is a threshold parameter of this event (A4-Threshold defined in reportConfigNR of this event).

The event A5 indicates that a measurement result of a serving cell is lower than a measurement result of a neighboring cell by over a threshold 1, or a measurement result of a neighboring cell is higher than a measurement result of a serving cell by over a threshold 2. The entering condition and the leaving condition of the event A5 are as follows:

$$Entering condition :$$

$$Mp + Hys < Thresh 1 ; and$$

$$Mn + Ofn + Ocn - Hys > Thresh 2.$$

$$Leaving condition :$$

$$Mp - Hys > Thresh 1 ; and$$

$$Mn + Of n + O cn + Hys < Thresh 2.$$

To resolve the foregoing interference problem of the UAV without increasing excessive signalling overheads of measurement reports, RRM (Radio Resource Management, radio resource management) measurement triggered by the events A3, A4, and A5 is further enhanced in LTE. The network configures numberOfTriggeringCells for the events A3, A4, and A5. When the number of cells entering the event is greater than or equal to numberOfTriggeringCells, the UE triggers measurement reporting. For A4 and A5, a4-a5-ReportOnLeave is further defined (A3 already has this parameter), that is, to indicate whether the UE initiates measurement reporting when a cell in a cell in a cell trigger list cellsTriggeredList meets a leaving condition.

Optionally, the second event is a mobility management-dependent event.

In this embodiment of this application, the second event may be an event A3 (an enhanced event A3), an event A4 (an enhanced event A4), or an event A5 (an enhanced event A5).

The combination of the first event and the second event forms a new event type, which is referred to as a combination event. The introduction of the combination event can effectively reduce signalling overheads of measurement reporting.

Optionally, the network side device delivers the first configuration information to the terminal by using dedicated signalling, and the terminal receives, by using dedicated signalling, the first configuration information sent by the network side device. The dedicated signalling may be radio resource control (Radio Resource Control, RRC) signalling, media access control control element (Media Access Control Control Element, MAC CE) signalling, or the like.

The first configuration information is used to indicate the configuration of the combination event by the network side device, to implement the configuration of the combination event.

Step 202: The terminal performs measurement, and determines, based on the first configuration information and whether an entering condition or a leaving condition of the combination event is met in a measurement process, whether to perform measurement reporting.

After receiving the first configuration information, the terminal can obtain the configuration of the combination event by the network side device based on the first configuration information, so that in the measurement process, it can be determined whether the entering condition of the combination event is met, whether the leaving condition of the combination event is met, whether a value of reportOnLeave is true, or whether the number of cells in a cell trigger list corresponding to the combination event meets a cell number threshold, so as to determine whether to perform measurement reporting.

In this embodiment of this application, first configuration information sent by a network side device is received, and a configuration of a combination event by the network side device is obtained, where the combination event is a combination event constituted by a terminal height-dependent event and a mobility management-dependent event. Then, the terminal performs measurement, and determines, based on whether an entering condition or a leaving condition of the combination event is met in a measurement process or whether the number of cells in a cell trigger list corresponding to the combination event meets a cell number threshold, whether to perform measurement reporting, so that for the combination event constituted by the terminal height-dependent event and the mobility management-dependent event, measurement reporting can be performed only when a condition for measurement reporting is met, thereby reducing signalling overheads of measurement reporting while reducing interference on the terminal.

In some embodiments, the first configuration information includes at least one of the following: (1) type information of at least one combination event; or (2) a cell number threshold triggering measurement reporting and corresponding to each combination event.

The network side device configures the type information of the at least one combination event. Based on the type information of the combination event, the terminal may learn a specific type of the combination event, an entering condition or a leaving condition of the combination event, and some parameters related to measurement reporting. For example, the combination event is formed by combining the first event H1 and the second event A4, and the combination event is H1A4. The network side device may configure parameters in the entering condition or the leaving condition of H1A4, and parameters related to measurement reporting, such as a parameter related to a condition for triggering measurement reporting, a measurement report corresponding to an event to be reported, a reporting interval, and the number of reporting times.

Optionally, the network side device configures numberOfTriggeringCells for each combination event, where numberOfTriggeringCells is a cell number threshold for triggering measurement reporting, which is referred to as a cell number threshold.

Optionally, each combination event corresponds to one measurement identity measID, and cellsTriggeredList and numberOfTriggeringCells are maintained in each measID.

CellsTriggeredList is a cell trigger list locally maintained by the terminal, and numberOfTriggeringCells is configured by the network side device.

When a cell meets the entering condition of the combination event, the cell is added to cellsTriggeredList, and when the number of cells in cellsTriggeredList is greater than or equal to numberOfTriggeringCells, measurement reporting is triggered. When a cell meets the leaving condition of the combination event, the cell is removed from cellsTriggeredList.

In this embodiment of this application, the terminal obtains, by receiving the first configuration information, the type information that is of the at least one combination event and configured by the network side device. Optionally, a cell number threshold corresponding to each combination event is further obtained, so that an entering condition and a leaving condition of the combination event and a condition for triggering measurement reporting can be determined, thereby effectively reducing overheads of measurement reporting.

In some embodiments, for each combination event, type information of the combination event includes at least one of the following:

(a) Hysteresis factor, including a hysteresis factor of the first event and a hysteresis factor of the second event.

For the first event and the second event, the network side device separately configures corresponding hysteresis factors (Hysteresis).

(b) Threshold, including a threshold of the first event and a threshold (threshold) of the second event.

For the first event and the second event, the network side device separately configures corresponding thresholds.

The terminal may determine the entering condition and the leaving condition of the combination event based on the hysteresis factor and the threshold.

(c) Time to trigger (Time to trigger, TTT), where the time to trigger is used to indicate to trigger measurement reporting in a case that an entering condition of the combination event is met and duration is greater than or equal to the time to trigger.

If the entering condition of the combination event is met, a TTT timer is enabled. Within an allowed time of the TTT, if the entering condition of the combination event is always met, or an entering condition of any event among the first event and the second event is always met, or an entering condition that is of a specified event among the first event and the second event and indicated by the network side device is always met, measurement reporting is triggered.

It can be understood that if the entering condition of the combination event is met and duration in which the entering condition is met is less than the time to trigger, measurement reporting is not triggered.

(d) Value of reportOnLeave, where the value of reportOnLeave is used to indicate whether to initialize a measurement reporting procedure when a leaving condition of the combination event is met.

When the value of reportOnLeave is True and the leaving condition of the combination event is met, the measurement reporting procedure is initialized, that is, measurement reporting is performed. When the value of reportOnLeave is False and the leaving condition of the combination event is met, measurement reporting is not triggered.

In this embodiment of this application, the terminal may obtain at least one of the hysteresis factor, the threshold, the time to trigger, or the value of reportOnLeave based on the type information of the combination event, so that the entering condition and the leaving condition of the combination event and the condition for triggering measurement reporting can be determined, thereby reducing overheads of measurement reporting while effectively reducing interference on the terminal.

Optionally, the entering condition of the combination event includes: an entering condition of the first event and an entering condition of the second event are both met.

For example, for a combination event A4H1, an entering condition thereof may be Ms−Hys1>H1−Threshold+Offset & Mn+Ofn+Ocn−a4−hysteresis>a4−Threshold.

For another example, for a combination event A4H1H2, an entering condition thereof may be H1−Threshold+hys1+offsetH1<Ms<H2−Threshold−Hys2+OffsetH2 & Mn+Ofn+Ocn−a4−hysteresis>a4−Threshold.

It can be understood that, the entering condition of the combination event is met only when the entering condition of the first event and the entering condition of the second event are both met.

In this embodiment of this application, it is considered that the entering condition of the combination event is met only in a case that the entering condition of the first event and the entering condition of the second event are both met, thereby effectively reducing overheads of measurement reporting.

Optionally, the leaving condition of the combination event includes at least one of the following:

(a) A leaving condition of the first event and a leaving condition of the second event are both met.

For example, for a combination event A4H1, a leaving condition thereof may be Ms+Hys1<H1−Threshold+Offset & Mn+Ofn+Ocn+a4−hysteresis<a4−Threshold.

For another example, for a combination event A4H1H2, a leaving condition thereof may be H2−Threshold+Hys2+offsetH1<Ms<H1−Threshold−Hys1+OffsetH1 & Mn+Ofn+Ocn+a4−hysteresis<a4−Threshold.

(b) A leaving condition of any event among the first event and the second event is met.

It can be understood that in this embodiment, if a leaving condition of any event in the combination event is met, it is considered that the leaving condition of the combination event is met.

(c) A leaving condition of a first specified event among the first event and the second event is met.

It can be understood that when the leaving condition of the first specified event is met, it is considered that the leaving condition of the combination event is met.

The first specified event is configured by the network side device or specified in a protocol.

In this embodiment of this application, a plurality cases of the leaving condition of the combination event are provided, thereby effectively reducing overheads of measurement reporting.

Optionally, that the time to trigger is used to indicate to trigger measurement reporting in a case that the entering condition is met and the duration is greater than or equal to the time to trigger includes at least one of the following:

(a) After an entering condition of the first event and an entering condition of the second event are both met, if the entering condition of the first event and the entering condition of the second event are always met within the time to trigger, measurement reporting is triggered or a first cell is added to a cell trigger list corresponding to the combination event, where the first cell is a neighboring cell that meets the entering condition of the first event and the entering condition of the second event.

In an implementation, after the entering condition of the first event and the entering condition of the second event are both met, if the entering condition of the first event and the entering condition of the second event are always met within the time to trigger, measurement reporting is triggered.

In another optional implementation, after the entering condition of the first event and the entering condition of the second event are both met, if the entering condition of the first event and the entering condition of the second event are always met within the time to trigger, the first cell is added to the cell trigger list corresponding to the combination event, and in a case that the number of cells in the cell trigger list is greater than or equal to a cell number threshold corresponding to the combination event, the terminal performs measurement reporting.

(b) After an entering condition of the first event and an entering condition of the second event are both met, if an entering condition of any event among the first event and the second event is always met within the time to trigger, measurement reporting is triggered or a first cell is added to a cell trigger list corresponding to the combination event, where the first cell is a neighboring cell that meets the entering condition of any event among the first event and the second event.

In an implementation, after the entering condition of the first event and the entering condition of the second event are both met, if the entering condition of any event among the first event and the second event is always met within the time to trigger, measurement reporting is triggered.

In another optional implementation, after the entering condition of the first event and the entering condition of the second event are both met, if the entering condition of any event among the first event and the second event is always met within the time to trigger, the first cell is added to the cell trigger list corresponding to the combination event, and in a case that the number of cells in the cell trigger list is greater than or equal to a cell number threshold corresponding to the combination event, the terminal performs measurement reporting.

(c) After an entering condition of the first event and an entering condition of the second event are both met, if an entering condition of a second specified event among the first event and the second event is always met within the time to trigger, measurement reporting is triggered or a first cell is added to a cell trigger list corresponding to the combination event, where the first cell is a neighboring cell that meets the entering condition of the second specified event.

In an implementation, after the entering condition of the first event and the entering condition of the second event are both met, if the entering condition of the second specified event is always met within the time to trigger, measurement reporting is triggered. The second specified event is configured by the network side device or specified in a protocol.

In another optional implementation, after the entering condition of the first event and the entering condition of the second event are both met, if the entering condition of the first event and the entering condition of the second event are always met within the time to trigger, the first cell is added to the cell trigger list corresponding to the combination event, and in a case that the number of cells in the cell trigger list is greater than or equal to a cell number threshold corresponding to the combination event, the terminal performs measurement reporting.

The following describes this embodiment in detail by using two specific examples.

Example 1: Addition of a cell in cellsTriggeredList of a combination event and triggering of a measurement report includes the following steps:

Step 1: UE receives first configuration information by using dedicated signalling, where the first configuration information includes a related configuration of a combination event. For example, a network side configures an event A4H1 and corresponding numberOfTriggeringCells in ReportConfigNR.

Step 2: The UE performs measurement, and starts a TTT timer if a cell 1, a cell 2, and a cell 3 meet an entering condition of the event A4H1 in a measurement process, where an event A4 and an event H1 always meet the entering condition within a running period of the TTT timer.

Step 3: The UE adds a corresponding measurement report to a measurement report list VarMeasReportList for a corresponding measurement identity measID, and the UE adds the cell 1, the cell 2, and the cell 3 to cellsTriggeredList corresponding to measID.

Step 4: The UE performs measurement reporting when determining that the number of cells in cellsTriggeredList is greater than or equal to numberOfTriggeringCells corresponding to the event A4H1.

Example 2: A network indicates that if a specified event is entered and it lasts for TTT, measurement result reporting is triggered. The following steps are included:

Step 1: UE receives first configuration information by using dedicated signalling, where the first configuration information includes a related configuration of a combination event. After an entering condition of an event A4H1 is met, when H1 always meets an entering condition within TTT, the UE may trigger measurement reporting or add a cell to cellsTriggeredList corresponding to measID.

Step 2: The UE performs measurement, and starts a TTT timer for the event H1 if a cell 1 meets the entering condition of the event A4H1 in a measurement process. Within the TTT, the event H1 in the event A4H1 always meets the entering condition.

Step 3: The UE adds a corresponding measurement report to VarMeasReportList for measID corresponding to the event A4H1, and adds the cell 1 to cellsTriggeredList corresponding to measID.

In this embodiment of this application, the network side device configures the time to trigger for the terminal to instruct the terminal to perform the following operation: After the entering condition of the combination event is met, only when the entering condition of the combination event is always met within the time to trigger, or when the entering condition of any event among the first event and the second event is always met within the time to trigger, or when the entering condition of the second specified event is always met within the time to trigger, the terminal performs measurement reporting, or the terminal adds the cell that meets the entering condition to the cell trigger list corresponding to the combination event, and in a case that the number of cells in the cell trigger list is greater than or equal to the cell number threshold corresponding to the combination event, the terminal performs measurement reporting, thereby using less overheads of measurement reporting and resolving an interference problem of the terminal.

In some embodiments, the time to trigger is a plurality of times to trigger separately configured by the network side device for the first event and the second event. Optionally, the time to trigger may alternatively be one time to trigger configured by the network side device for the combination event.

In this way, a condition for reporting a measurement report by the terminal can be flexibly configured, thereby using less overheads of measurement reporting and resolving an interference problem of the terminal.

In some embodiments, in a case that the value of reportOnLeave is True, the terminal performs at least one of the following:
reporting a measurement report and removing a second cell from a cell trigger list corresponding to the combination event when a leaving condition of any event among the first event and the second event is met, where the second cell is a neighboring cell that meets the leaving condition of any event among the first event and the second event;
reporting a measurement report and removing a second cell from a cell trigger list corresponding to the combination event when a leaving condition of the first event and a leaving condition of the second event are both met, where the second cell is a neighboring cell that meets the leaving condition of the first event and the leaving condition of the second event;
reporting a measurement report and removing a second cell from a cell trigger list corresponding to the combination event when a leaving condition of a third specified event among the first event and the second event is met, where the second cell is a neighboring cell that meets the leaving condition of the third specified event, and the third specified event is configured by the network side device or specified in a protocol; or
deleting a cell trigger list corresponding to the combination event when a leaving condition of the first event is met.

It can be understood that the network side device configures a corresponding value of reportOnLeave for each combination event. If the value of reportOnLeave of the combination event is True, when a leaving condition of the combination event is met, a measurement report is reported, and a cell that meets the leaving condition of the combination event is removed from a cell trigger list corresponding to the combination event. The leaving condition of the combination event has been elaborated in the foregoing embodiment, and details are not described herein again.

Optionally, a measurement report is reported and a second cell is removed from a cell trigger list corresponding to the combination event when a leaving condition of any event among the first event and the second event is met, where the second cell is a neighboring cell that meets the leaving condition of any event among the first event and the second event, the measurement report carries first indication information, and the first indication information is used to indicate, to the network side device, a specified event that meets the leaving condition.

Optionally, the first event is a terminal height-dependent event. When the first event meets the leaving condition, it indicates that the terminal flies out of a specified height in this case. The second event in the combination event does not meet a specified height range, that is, all cells in the cell trigger list do not meet the height range in the combination event. Therefore, the cell trigger list corresponding to the combination event may be directly deleted.

The following describes this embodiment in detail by using a specific example.

Example 3: A network indicates that if a specified event leaves, measurement result reporting is triggered. The following steps are included:

Step 1: UE receives first configuration information by using dedicated signalling, where the first configuration information includes a related configuration of a combination event. For example, a network side configures an event A4H1 in ReportConfigNR, a corresponding value of ReportOnLeave, and numberOfTriggeringCells, and the network side indicates to trigger measurement reporting when a height of the terminal does not meet a threshold of an event H1 and ReportOnLeave is set to true; or the network may indicate to trigger measurement reporting when a specified event leaves and ReportOnLeave is set to true, where the specified event leaves means that the entire combination event leaves.

Step 2: The UE performs measurement, and the height of the UE meets a leaving condition of the threshold of the event H1 in a measurement process.

Step 3: The UE clears or deletes cellsTriggeredList and reports a measurement report.

In this embodiment of this application, the network side device configures a corresponding value of reportOnLeave for each combination event to indicate whether the terminal reports a measurement report when a leaving condition of the combination event is met, so that a condition for reporting a measurement report by the terminal can be flexibly configured, thereby using less overheads of measurement reporting and resolving an interference problem of the terminal.

In some embodiments, the determining, based on the first configuration information and whether an entering condition or a leaving condition of the combination event is met in a measurement process, whether to perform measurement reporting includes:
if the terminal determines that cell trigger lists corresponding to N combination events are totally the same or all include a same cell, and the number of cells included in a cell trigger list corresponding to each of the N combination events is greater than a cell number threshold corresponding to each of the N combination events, reporting, by the terminal, a measurement report only once, where
the measurement report reported by the terminal is a measurement report corresponding to any one of the N combination events or a measurement report reported based on an instruction of the network side device; and
N is a positive integer greater than 1.

It can be understood that the network side device configures a plurality of combination events for the terminal. When different cellsTriggeredList corresponding to different measID overlap and the number of cells in cellsTriggeredList is greater than or equal to numberOfTriggeringCells, the UE performs the following operation: The UE reports a measurement report corresponding to one of measIDs, and a specific to-be-reported measurement report corresponding to which measID may be configured by the network or based on UE implementation.

Overlapping means that cells included in different cellsTriggeredList corresponding to different measID are totally the same or all include a same cell.

In this embodiment of this application, when different cellsTriggeredList corresponding to different measID overlap and the number of cells in cellsTriggeredList is greater than or equal to numberOfTriggeringCells, the terminal reports a measurement report only once, thereby effectively reducing overheads of measurement reporting.

Optionally, the method further includes:
in a measurement process of the terminal, if a same cell or different cells simultaneously meet a leaving condition in overlapping cell trigger lists corresponding to different measurement identities, removing the cell that meets the leaving condition from a corresponding cell trigger list, and reporting a measurement report once, where the measurement report reported by the terminal is a measurement report corresponding to any one of the measurement identities or a measurement report reported based on an instruction of the network side device; and
N is a positive integer greater than 1.

It can be understood that when a same cell or different cells simultaneously meet a leaving condition in overlapping cellsTriggeredList corresponding to different measID, the UE performs the following operation: For the cell that meets the leaving condition, the UE removes the cell from respective corresponding cellstriggeredList, but reports a measurement report only once. A specific to-be-reported measurement report corresponding to which measID may be configured by the network or based on UE implementation. Because the UE reports a measurement report only once, thereby effectively reducing overheads of measurement reporting.

In some optional embodiments, the determining, based on the first configuration information and whether an entering condition or a leaving condition of the combination event is met in a measurement process, whether to perform measurement reporting includes:
in a measurement process, if a third cell meets an entering condition of a first combination event in N combination events and duration in which the entering condition is met is greater than or equal to a time to trigger corresponding to the first combination event, adding the third cell to a cell trigger list of the first combination event, and if the number of cells included in the cell trigger list corresponding to the first combination event is greater than a corresponding cell number threshold, reporting, by the terminal, a measurement report and starting a first timer; and
during running of the first timer, if the third cell meets an entering condition of a second combination event in the N combination events and duration in which the entering condition is met is greater than or equal to a time to trigger corresponding to the second combination event, adding the third cell to a cell trigger list of the second combination event, and if the first combination event and the second combination event correspond to a same cell trigger list, no longer reporting, by the terminal, a measurement report, where
duration of the first timer is configured by the network side device or specified in a protocol; and
N is a positive integer greater than 1.

Specifically, the terminal performs measurement. In the measurement process, if the third cell meets the entering condition of the first combination event in the N combination events and the duration in which the entering condition is met is greater than or equal to the time to trigger corresponding to the first combination event, that is, duration in which the third cell meets the entering condition of the first combination event is greater than the time to trigger corresponding to the first combination event, or duration in which the third cell meets an entering condition of any event constituting the first combination event is greater than the time to trigger corresponding to the first combination event, or duration in which the third cell meets an entering condition of a specified event constituting the first combination event is greater than the time to trigger corresponding to the first combination event, the third cell is added to the cell trigger list corresponding to the first combination event, and if the number of cells included in the cell trigger list corresponding to the first combination event is greater than the corresponding cell number threshold, the terminal reports the measurement report and starts the first timer.

During running of the first timer, if the third cell meets the entering condition of the second combination event in the N combination events and the duration in which the entering condition is met is greater than or equal to the time to trigger corresponding to the second combination event, that is, duration in which the third cell meets the entering condition of the second combination event is greater than the time to trigger corresponding to the second combination event, or duration in which the third cell meets an entering condition of any event constituting the second combination event is greater than the time to trigger corresponding to the second combination event, or duration in which the third cell meets an entering condition of a specified event constituting the second combination event is greater than the time to trigger corresponding to the second combination event, the third cell is added to the cell trigger list corresponding to the second combination event. In this case, the cell trigger list corresponding to the second combination event in the N combination events is totally the same as the cell trigger list corresponding to the first combination event, and the number of cells included in the cell trigger list corresponding to the second combination event is also greater than the corresponding cell number threshold, but the terminal no longer reports a measurement report.

The duration of the first timer is configured by the network side device or specified in a protocol.

Optionally, the determining, based on the first configuration information and whether an entering condition or a leaving condition of the combination event is met in a measurement process, whether to perform measurement reporting includes:
in a measurement process, when different cell trigger lists corresponding to different combination events overlap successively and each combination event meets a respective entering condition, if the terminal has reported a measurement report within first duration, no longer reporting, by the terminal, a measurement report, where
the first duration is configured by the network side device or specified in a protocol.

Specifically, the terminal performs measurement. In the measurement process, if the third cell meets the entering condition of the first combination event in the N combination events and the duration in which the entering condition is met is greater than or equal to the time to trigger corresponding to the first combination event (that is, duration in which the third cell meets the entering condition of the first combination event is greater than the time to trigger corresponding to the first combination event, or duration in which the third cell meets an entering condition of any event constituting the first combination event is greater than the time to trigger corresponding to the first combination event, or duration in which the third cell meets an entering condition of a specified event constituting the first combination event is greater than the time to trigger corresponding to the first combination event), the third cell is added to the cell trigger list corresponding to the first combination event, and if the number of cells included in the cell trigger list corresponding to the first combination event is greater than the corresponding cell number threshold, the terminal reports the measurement report.

If the third cell meets the entering condition of the second combination event in the N combination events within the first duration and the duration in which the entering condition is met is greater than or equal to the time to trigger corresponding to the second combination event (that is, duration in which the third cell meets the entering condition of the second combination event is greater than the time to trigger corresponding to the second combination event, or duration in which the third cell meets an entering condition of any event constituting the second combination event is greater than the time to trigger corresponding to the second combination event, or duration in which the third cell meets an entering condition of a specified event constituting the second combination event is greater than the time to trigger corresponding to the second combination event), the third cell is added to the cell trigger list corresponding to the second combination event. In this case, the cell trigger list corresponding to the second combination event in the N combination events is totally the same as the cell trigger list corresponding to the first combination event, and the number of cells included in the cell trigger list corresponding to the second combination event is also greater than the corresponding cell number threshold, but the terminal no longer reports a measurement report.

The first duration is configured by the network side device or specified in a protocol.

Optionally, when different cellsTriggeredList corresponding to different measID overlap successively within a short time, and an entering condition is met, or measurement reporting has been triggered within a short time, the UE performs one of the following operations:
if a measurement report has been reported within a specified time and same cellTriggeredList appears, no longer performing reporting, where the specified time may be configured by the network or specified in a protocol;
if a measurement report has been reported within a specified time, no longer performing reporting, where the specified time may be configured by the network or specified in a protocol; or
when the number of cells in cellstriggeredList meets a reporting condition, starting a first timer, and during running of the timer, when same cellsTriggeredList appears, the reporting condition is met, or measurement reporting is triggered again, no longer reporting a measurement report.

In this embodiment of this application, in a case that different cellsTriggeredList corresponding to different measID overlap successively within a short time, overheads of measurement reporting can be effectively reduced.

In some embodiments, the method further includes:
in a case that a first combination event and a second combination event correspond to a same cell trigger list in a measurement process of the terminal,
if a fourth cell meets a leaving condition of the first combination event in an ongoing measurement process of the terminal, removing, by the terminal, the fourth cell from a cell trigger list corresponding to the first combination event, reporting a measurement report, and starting a second timer; and
if a fifth cell meets a leaving condition of the second combination event during running of the second timer, removing, by the terminal, the fifth cell from a cell trigger list corresponding to the second combination event, and no longer reporting a measurement report, where
duration of the second timer is configured by the network side device or specified in a protocol, and the fifth cell is the same as or different from the fourth cell.

In some embodiments, the method further includes:
in a case that a first combination event and a second combination event correspond to a same cell trigger list in a measurement process of the terminal,
if a fourth cell meets a leaving condition of the first combination event in an ongoing measurement process of the terminal, removing, by the terminal, the fourth cell from a cell trigger list corresponding to the first combination event, and reporting a measurement report; and
if a fifth cell meets a leaving condition of the second combination event within second duration, removing, by the terminal, the fifth cell from a cell trigger list corresponding to the second combination event, and no longer reporting a measurement report, where
the second duration is configured by the network side device or specified in a protocol, and the fifth cell is the same as or different from the fourth cell.

Optionally, when a same cell or different cells successively meet a leaving condition in overlapping cellsTriggeredList corresponding to different measID, or measurement reporting has been triggered within a short time, the UE performs one of the following operations:
within a specified time, if a cell meets a leaving condition and a measurement report has been reported, and the cell meets the leaving condition in another same cellsTriggeredList, no longer performing reporting, where the specified time may be configured by the network or specified in a protocol; or
within a specified time, if a cell meets a leaving condition and a measurement report has been reported, no longer performing reporting, where the specified time may be configured by the network or specified in a protocol; or
when a cell in cellsTriggeredList meets a leaving condition and a measurement report has been reported, starting a second timer is started, and during running of the timer, when the cell leaves another same cellsTriggeredList or measurement reporting is triggered again, no longer reporting a measurement report.

In this embodiment of this application, in a case that a same cell or different cells successively meet a leaving condition in overlapping cellsTriggeredList corresponding to different measID, or measurement reporting is triggered within a short time, a measurement report is no longer reported, thereby effectively reducing overheads of measurement reporting.

In this embodiment of this application, first configuration information sent by a network side device is received, and a configuration of a combination event by the network side device is obtained, where the combination event is a combination event constituted by a terminal height-dependent event and a mobility management-dependent event. Then, the terminal performs measurement, and determines, based on whether an entering condition or a leaving condition of the combination event is met in a measurement process or whether the number of cells in a cell trigger list corresponding to the combination event meets a cell number threshold, whether to perform measurement reporting, so that measurement reporting can be performed only when the entering condition of the combination event or the leaving condition of the combination event is met and a value of reportOnLeave is True or the number of cells in the cell trigger list corresponding to the combination event is greater than the cell number threshold, thereby reducing signalling overheads of measurement reporting while reducing interference on the terminal.

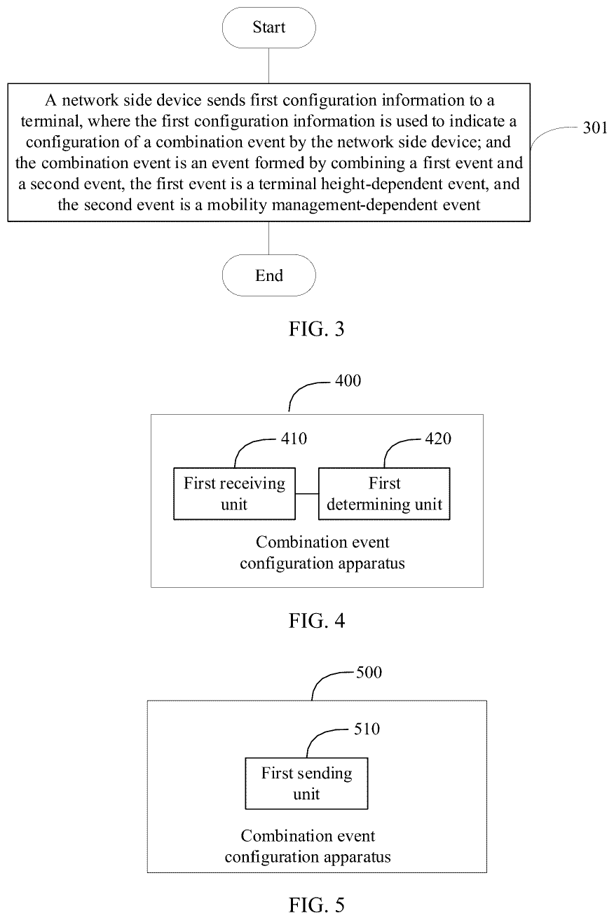

FIG. 3 is a second schematic flowchart of a combination event configuration method according to an embodiment of this application. As shown in FIG. 3, the method includes the following steps:

Step 301: A network side device sends first configuration information to a terminal, where the first configuration information is used to indicate a configuration of a combination event by the network side device.

The combination event is an event formed by combining a first event and a second event, the first event is a terminal height-dependent event, and the second event is a mobility management-dependent event.

Optionally, the first configuration information includes at least one of the following: type information of at least one combination event; or a cell number threshold triggering measurement reporting and corresponding to each combination event.

Optionally, for each combination event, type information of the combination event includes at least one of the following:
a hysteresis factor, including a hysteresis factor of the first event and a hysteresis factor of the second event;
a threshold, including a threshold of the first event and a threshold of the second event;
a time to trigger, where the time to trigger is used to indicate to trigger measurement reporting in a case that an entering condition of the combination event is met and duration is greater than or equal to the time to trigger; or
a value of reportOnLeave, where the value of reportOnLeave is used to indicate whether to initialize a measurement reporting procedure when a leaving condition of the combination event is met.

Optionally, the network side device further configures a first specified event for the terminal, where the first specified event is an event among the first event and the second event, and the leaving condition of the combination event is met when a leaving condition of the first specified event is met.

Optionally, the network side device further configures a second specified event for the terminal, where the second specified event is an event among the first event and the second event, and the second specified event is used to: after an entering condition of the first event and an entering condition of the second event are both met, if an entering condition of the second specified event is always met within the time to trigger, trigger the terminal to perform the following operation: reporting a measurement report or adding a first cell to a cell trigger list corresponding to the combination event, where the first cell is a neighboring cell that meets the entering condition of the second specified event.

Optionally, the time to trigger is a plurality of times to trigger separately configured by the network side device for the first event and the second event or one time to trigger configured for the combination event.

Optionally, the network side device further configures a third specified event for the terminal, where the third specified event is an event among the first event and the second event, and the third specified event is used to: in a case that the value of reportOnLeave is True, if a leaving condition of the third specified event is met, trigger the terminal to perform the following operations: reporting a measurement report and removing a second cell from a cell trigger list corresponding to the combination event, where the second cell is a neighboring cell that meets the leaving condition of the third specified event.

Optionally, the method further includes:
sending, by the network side device, measurement reporting indication information to the terminal, where the measurement reporting indication information is used to instruct the terminal to report a measurement report of a target combination event.

Optionally, the network side device further configures duration of a first timer and duration of a second timer for the terminal, the duration of the first timer is used to indicate an interval during which the terminal no longer transmits a measurement report in a case that cell trigger lists corresponding to different combination events overlap, and the duration of the second timer is used to indicate an interval during which the terminal no longer transmits a measurement report in a case that a same cell or different cells meet leaving conditions corresponding to different combination events.

Optionally, the network side device further configures first duration and second duration for the terminal, the first duration is used to indicate an interval during which the terminal no longer transmits a measurement report in a case that different cell trigger lists corresponding to different combination events overlap successively, and the second duration is used to indicate an interval during which the terminal no longer transmits a measurement report in a case that a same cell or different cells meet leaving conditions corresponding to different combination events.

The combination event configuration method provided in this embodiment of this application is described from the perspective of the network side device. For understanding of the foregoing method embodiment on the network side in this application, reference may be made to the foregoing method embodiment on the terminal side, and details are not described herein again.

The combination event configuration method provided in the embodiments of this application may be performed by a combination event configuration apparatus. In the embodiments of this application, an example in which the combination event configuration apparatus performs the combination event configuration method is used to describe the combination event configuration apparatus provided in the embodiments of this application.

FIG. 4 is a first schematic structural diagram of a combination event configuration apparatus according to an embodiment of this application. As shown in FIG. 4, the combination event configuration apparatus 400 includes:

a first receiving unit 410, configured to receive first configuration information sent by a network side device, where the first configuration information is used to indicate a configuration of a combination event by the network side device; and a first determining unit 420, configured to: perform measurement, and determine, based on the first configuration information and whether an entering condition or a leaving condition of the combination event is met in a measurement process, whether to perform measurement reporting, where the combination event is an event formed by combining a first event and a second event, the first event is a terminal height-dependent event, and the second event is a mobility management-dependent event.

Optionally, the first configuration information includes at least one of the following: type information of at least one combination event; or a cell number threshold triggering measurement reporting and corresponding to each combination event.

Optionally, for each combination event, type information of the combination event includes at least one of the following:
a hysteresis factor, including a hysteresis factor of the first event and a hysteresis factor of the second event;
a threshold, including a threshold of the first event and a threshold of the second event;
a time to trigger, where the time to trigger is used to indicate to trigger measurement reporting in a case that an entering condition of the combination event is met and duration is greater than or equal to the time to trigger; or
a value of reportOnLeave, where the value of reportOnLeave is used to indicate whether to initialize a measurement reporting procedure when a leaving condition of the combination event is met.

Optionally, the entering condition of the combination event includes: an entering condition of the first event and an entering condition of the second event are both met.

Optionally, the leaving condition of the combination event includes at least one of the following:
a leaving condition of the first event and a leaving condition of the second event are both met;
a leaving condition of any event among the first event and the second event is met; or
a leaving condition of a first specified event among the first event and the second event is met, where
the first specified event is configured by the network side device or specified in a protocol.

Optionally, that the time to trigger is used to indicate to trigger measurement reporting in a case that the entering condition is met and the duration is greater than or equal to the time to trigger includes at least one of the following:
after an entering condition of the first event and an entering condition of the second event are both met, if the entering condition of the first event and the entering condition of the second event are always met within the time to trigger, measurement reporting is triggered or a first cell is added to a cell trigger list corresponding to the combination event, where the first cell is a neighboring cell that meets the entering condition of the first event and the entering condition of the second event;
after an entering condition of the first event and an entering condition of the second event are both met, if an entering condition of any event among the first event and the second event is always met within the time to trigger, measurement reporting is triggered or a first cell is added to a cell trigger list corresponding to the combination event, where the first cell is a neighboring cell that meets the entering condition of any event among the first event and the second event; or
after an entering condition of the first event and an entering condition of the second event are both met, if an entering condition of a second specified event among the first event and the second event is always met within the time to trigger, measurement reporting is triggered or a first cell is added to a cell trigger list corresponding to the combination event, where the first cell is a neighboring cell that meets the entering condition of the second specified event, where
the second specified event is configured by the network side device or specified in a protocol.

Optionally, the time to trigger is a plurality of times to trigger separately configured for the first event and the second event or one time to trigger configured for the combination event.

Optionally, in a case that the value of reportOnLeave is True, the first determining unit 420 is further configured to perform at least one of the following:
reporting a measurement report and removing a second cell from a cell trigger list corresponding to the combination event when a leaving condition of any event among the first event and the second event is met, where the second cell is a neighboring cell that meets the leaving condition of any event among the first event and the second event;
reporting a measurement report and removing a second cell from a cell trigger list corresponding to the combination event when a leaving condition of the first event and a leaving condition of the second event are both met, where the second cell is a neighboring cell that meets the leaving condition of the first event and the leaving condition of the second event; reporting a measurement report and removing a second cell from a cell trigger list corresponding to the combination event when a leaving condition of a third specified event among the first event and the second event is met, where the second cell is a neighboring cell that meets the leaving condition of the third specified event, and the third specified event is configured by the network side device or specified in a protocol; or
deleting a cell trigger list corresponding to the combination event when a leaving condition of the first event is met.

Optionally, the terminal performs measurement reporting in a case that the number of cells in the cell trigger list is greater than or equal to the cell number threshold corresponding to the combination event.

Optionally, the first determining unit 420 is configured to:
if it is determined that cell trigger lists corresponding to N combination events are totally the same or all include a same cell, and the number of cells included in a cell trigger list corresponding to each of the N combination events is greater than a cell number threshold corresponding to each of the N combination events, report a measurement report only once, where
the reported measurement report is a measurement report corresponding to any one of the N combination events or a measurement report reported based on an instruction of the network side device; and
N is a positive integer greater than 1.

Optionally, the first determining unit 420 is further configured to:
in a measurement process, if a same cell or different cells simultaneously meet a leaving condition in overlapping cell trigger lists corresponding to different measurement identities, remove the cell that meets the leaving condition from a corresponding cell trigger list, and, and report a measurement report once, where
the reported measurement report is a measurement report corresponding to any one of the measurement identities or a measurement report reported based on an instruction of the network side device; and
N is a positive integer greater than 1.

Optionally, the first determining unit 420 is configured to:
in a measurement process, if a third cell meets an entering condition of a first combination event in N combination events and duration in which the entering condition is met is greater than or equal to a time to trigger corresponding to the first combination event, add the third cell to a cell trigger list of the first combination event, report a measurement report, and start a first timer, where the number of cells included in the cell trigger list corresponding to the first combination event is greater than a corresponding cell number threshold; and
during running of the first timer, if the third cell meets an entering condition of a second combination event in the N combination events and duration in which the entering condition is met is greater than or equal to a time to trigger corresponding to the second combination event, add the third cell to a cell trigger list of the second combination event, and no longer report a measurement report if the first combination event and the second combination event correspond to a same cell trigger list, where duration of the first timer is configured by the network side device or specified in a protocol; and
N is a positive integer greater than 1.

Optionally, the first determining unit 420 is configured to:
in a measurement process, when different cell trigger lists corresponding to different combination events overlap successively and each combination event meets a respective entering condition, no longer report a measurement report if a measurement report has been reported within first duration, where
the first duration is configured by the network side device or specified in a protocol.

Optionally, the first determining unit 420 is further configured to:
in a case that a first combination event and a second combination event correspond to a same cell trigger list in a measurement process,
if a fourth cell meets a leaving condition of the first combination event in an ongoing measurement process, remove the fourth cell from a cell trigger list corresponding to the first combination event, report a measurement report, and start a second timer; and
if a fifth cell meets a leaving condition of the second combination event during running of the second timer, remove the fifth cell from a cell trigger list corresponding to the second combination event, and no longer report a measurement report, where
duration of the second timer is configured by the network side device or specified in a protocol, and the fifth cell is the same as or different from the fourth cell.

Optionally, the first determining unit 420 is further configured to:
in a case that a first combination event and a second combination event correspond to a same cell trigger list in a measurement process,
if a fourth cell meets a leaving condition of the first combination event in an ongoing measurement process, remove the fourth cell from a cell trigger list corresponding to the first combination event, and report a measurement report; and
if a fifth cell meets a leaving condition of the second combination event within second duration, remove the fifth cell from a cell trigger list corresponding to the second combination event, and no longer report a measurement report, where
the second duration is configured by the network side device or specified in a protocol, and the fifth cell is the same as or different from the fourth cell.

The combination event configuration apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed type of the terminal 11. The another device may be a server, a network attached storage (Network Attached Storage, NAS), or the like. This is not specifically limited in this embodiment of this application.

The combination event configuration apparatus provided in this embodiment of this application can implement the processes implemented in the method embodiment of FIG. 2, and achieve a same technical effect. To avoid repetition, details are not described herein again.

FIG. 5 is a second schematic structural diagram of a combination event configuration apparatus according to an embodiment of this application. As shown in FIG. 5, the combination event configuration apparatus 500 includes:
a first sending unit 510, configured to send first configuration information to a terminal, where the first configuration information is used to indicate a configuration of a combination event by the network side device; and
the combination event is an event formed by combining a first event and a second event, the first event is a terminal height-dependent event, and the second event is a mobility management-dependent event.

Optionally, the first configuration information includes at least one of the following:
type information of at least one combination event; or
a cell number threshold triggering measurement reporting and corresponding to each combination event.

Optionally, for each combination event, type information of the combination event includes at least one of the following:
a hysteresis factor, including a hysteresis factor of the first event and a hysteresis factor of the second event;
a threshold, including a threshold of the first event and a threshold of the second event;
a time to trigger, where the time to trigger is used to indicate to trigger measurement reporting in a case that an entering condition of the combination event is met and duration is greater than or equal to the time to trigger; or
a value of reportOnLeave, where the value of reportOnLeave is used to indicate whether to initialize a measurement reporting procedure when a leaving condition of the combination event is met.

Optionally, the combination event configuration apparatus further configures a first specified event for the terminal, where the first specified event is an event among the first event and the second event, and the leaving condition of the combination event is met when a leaving condition of the first specified event is met.

Optionally, the combination event configuration apparatus further configures a second specified event for the terminal, where the second specified event is an event among the first event and the second event, and the second specified event is used to: after an entering condition of the first event and an entering condition of the second event are both met, if an entering condition of the second specified event is always met within the time to trigger, trigger the terminal to perform the following operation: reporting a measurement report or adding a first cell to a cell trigger list corresponding to the combination event, where the first cell is a neighboring cell that meets the entering condition of the second specified event.

Optionally, the time to trigger is a plurality of times to trigger separately configured by the network side device for the first event and the second event or one time to trigger configured for the combination event.

Optionally, the combination event configuration apparatus further configures a third specified event for the terminal, where the third specified event is an event among the first event and the second event, and the third specified event is used to: in a case that the value of reportOnLeave is True, if a leaving condition of the third specified event is met, trigger the terminal to perform the following operations: reporting a measurement report and removing a second cell from a cell trigger list corresponding to the combination event, where the second cell is a neighboring cell that meets the leaving condition of the third specified event.

Optionally, the apparatus further includes:
a second sending unit, configured to send measurement reporting indication information to the terminal, where the measurement reporting indication information is used to instruct the terminal to report a measurement report of a target combination event.

Optionally, the combination event configuration apparatus further configures duration of a first timer and duration of a second timer for the terminal, the duration of the first timer is used to indicate an interval during which the terminal no longer transmits a measurement report in a case that cell trigger lists corresponding to different combination events overlap, and the duration of the second timer is used to indicate an interval during which the terminal no longer transmits a measurement report in a case that a same cell or different cells meet leaving conditions corresponding to different combination events.

Optionally, the combination event configuration apparatus further configures first duration and second duration for the terminal, the first duration is used to indicate an interval during which the terminal no longer transmits a measurement report in a case that different cell trigger lists corresponding to different combination events overlap successively, and the second duration is used to indicate an interval during which the terminal no longer transmits a measurement report in a case that a same cell or different cells meet leaving conditions corresponding to different combination events.

The combination event configuration apparatus in this embodiment of this application may be an electronic device, for example, an electronic device with an operating system, or may be a component in the electronic device, for example, an integrated circuit or a chip. The electronic device may be a network side device, or may be another device other than the network side device. For example, the network side device may include but is not limited to the foregoing listed type of the network side device 12. The another device may be a server, a network attached storage (Network Attached Storage, NAS), or the like. This is not specifically limited in this embodiment of this application.

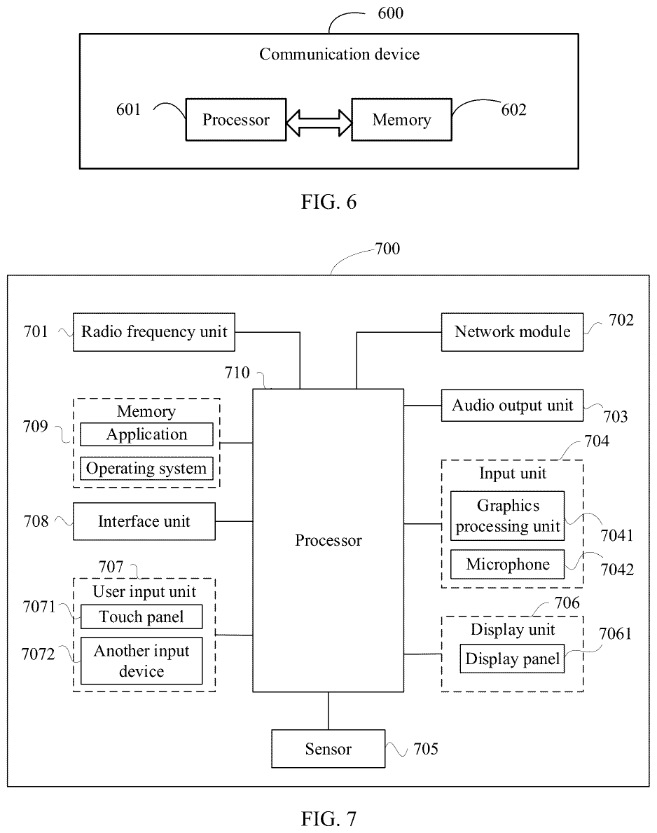

As shown in FIG. 6, an embodiment of this application further provides a communication device 600, including a processor 601 and a memory 602. The memory 602 stores a program or an instruction that can be run on the processor 601. For example, when the communication device 600 is a terminal, the program or the instruction is executed by the processor 601 to implement the steps of the foregoing combination event configuration method embodiment, and a same technical effect can be achieved. When the communication device 600 is a network side device, the program or the instruction is executed by the processor 601 to implement the processes of the foregoing combination event configuration method embodiment, and a same technical effect can be achieved. To avoid repetition, details are not described herein again.

An embodiment of this application further provides a terminal, including a processor and a communication interface. The communication interface is coupled to the processor, and the processor is configured to run a program or an instruction to implement the steps of the method embodiment shown in FIG. 2. This terminal embodiment corresponds to the foregoing method embodiment on the terminal side. Each implementation process and implementation of the foregoing method embodiment may be applicable to this terminal embodiment, and a same technical effect can be achieved. Specifically, FIG. 7 is a schematic structural diagram of hardware of a terminal according to an embodiment of this application.

The terminal 700 includes but is not limited to a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include the power supply (for example, a battery) that supplies power to each component. The power supply may be logically connected to the processor 710 by using a power supply management system, so as to manage functions such as charging, discharging, and power consumption by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 704 may include a graphics processing unit (Graphics Processing Unit, GPU) 7041 and a microphone 7042, and the graphics processing unit 7041 processes image data of a still image or a video that is obtained by an image capturing apparatus (for example, a camera) in a video capturing mode or an image capturing mode. The display unit 706 may include a display panel 7061. The display panel 7061 may be configured in a form such as a liquid crystal display or an organic light-emitting diode. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may include a volatile memory or a non-volatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 709 in this embodiment of this application includes but is not limited to these memories and a memory of any other proper type.

The processor 710 may include one or more processing units. Optionally, an application processor and a modem processor are integrated into the processor 710. The application processor mainly processes an operating system, a user interface, an application, and the like. The modem processor mainly processes a wireless communication signal, for example, a baseband processor. It can be understood that, alternatively, the modem processor may not be integrated into the processor 710.

The radio frequency unit 701 is configured to receive first configuration information sent by a network side device, where the first configuration information is used to indicate a configuration of a combination event by the network side device; and
the processor 710 is configured to: perform measurement, and determine, based on the first configuration information and whether an entering condition or a leaving condition of the combination event is met in a measurement process, whether to perform measurement reporting, where
the combination event is an event formed by combining a first event and a second event, the first event is a terminal height-dependent event, and the second event is a mobility management-dependent event.

Optionally, the first configuration information includes at least one of the following:
type information of at least one combination event; or
a cell number threshold triggering measurement reporting and corresponding to each combination event.

Optionally, for each combination event, type information of the combination event includes at least one of the following:
a hysteresis factor, including a hysteresis factor of the first event and a hysteresis factor of the second event;
a threshold, including a threshold of the first event and a threshold of the second event;
a time to trigger, where the time to trigger is used to indicate to trigger measurement reporting in a case that an entering condition of the combination event is met and duration is greater than or equal to the time to trigger; or
a value of reportOnLeave, where the value of reportOnLeave is used to indicate whether to initialize a measurement reporting procedure when a leaving condition of the combination event is met.

Optionally, the entering condition of the combination event includes: an entering condition of the first event and an entering condition of the second event are both met.

Optionally, the leaving condition of the combination event includes at least one of the following:
a leaving condition of the first event and a leaving condition of the second event are both met;
a leaving condition of any event among the first event and the second event is met; or
a leaving condition of a first specified event among the first event and the second event is met, where
the first specified event is configured by the network side device or specified in a protocol.

Optionally, that the time to trigger is used to indicate to trigger measurement reporting in a case that the entering condition is met and the duration is greater than or equal to the time to trigger includes at least one of the following:
after an entering condition of the first event and an entering condition of the second event are both met, if the entering condition of the first event and the entering condition of the second event are always met within the time to trigger, measurement reporting is triggered or a first cell is added to a cell trigger list corresponding to the combination event, where the first cell is a neighboring cell that meets the entering condition of the first event and the entering condition of the second event;
after an entering condition of the first event and an entering condition of the second event are both met, if an entering condition of any event among the first event and the second event is always met within the time to trigger, measurement reporting is triggered or a first cell is added to a cell trigger list corresponding to the combination event, where the first cell is a neighboring cell that meets the entering condition of any event among the first event and the second event; or
after an entering condition of the first event and an entering condition of the second event are both met, if an entering condition of a second specified event among the first event and the second event is always met within the time to trigger, measurement reporting is triggered or a first cell is added to a cell trigger list corresponding to the combination event, where the first cell is a neighboring cell that meets the entering condition of the second specified event, where
the second specified event is configured by the network side device or specified in a protocol.

Optionally, the time to trigger is a plurality of times to trigger separately configured for the first event and the second event or one time to trigger configured for the combination event.

Optionally, in a case that the value of reportOnLeave is True, the processor 710 performs at least one of the following:
reporting a measurement report and removing a second cell from a cell trigger list corresponding to the combination event when a leaving condition of any event among the first event and the second event is met, where the second cell is a neighboring cell that meets the leaving condition of any event among the first event and the second event;
reporting a measurement report and removing a second cell from a cell trigger list corresponding to the combination event when a leaving condition of the first event and a leaving condition of the second event are both met, where the second cell is a neighboring cell that meets the leaving condition of the first event and the leaving condition of the second event;
reporting a measurement report and removing a second cell from a cell trigger list corresponding to the combination event when a leaving condition of a third specified event among the first event and the second event is met, where the second cell is a neighboring cell that meets the leaving condition of the third specified event, and the third specified event is configured by the network side device or specified in a protocol; or
deleting a cell trigger list corresponding to the combination event when a leaving condition of the first event is met.

Optionally, the terminal performs measurement reporting in a case that the number of cells in the cell trigger list is greater than or equal to the cell number threshold corresponding to the combination event.

Optionally, the processor 710 is configured to:
if it is determined that cell trigger lists corresponding to N combination events are totally the same or all include a same cell, and the number of cells included in a cell trigger list corresponding to each of the N combination events is greater than a cell number threshold corresponding to each of the N combination events, report a measurement report only once, where
the reported measurement report is a measurement report corresponding to any one of the N combination events or a measurement report reported based on an instruction of the network side device; and
N is a positive integer greater than 1.

Optionally, the processor 710 is further configured to:
in a measurement process, if a same cell or different cells simultaneously meet a leaving condition in overlapping cell trigger lists corresponding to different measurement identities, remove the cell that meets the leaving condition from a corresponding cell trigger list, and, and report a measurement report once, where
the reported measurement report is a measurement report corresponding to any one of the measurement identities or a measurement report reported based on an instruction of the network side device; and
N is a positive integer greater than 1.

Optionally, the processor 710 is configured to:
in a measurement process, if a third cell meets an entering condition of a first combination event in N combination events and duration in which the entering condition is met is greater than or equal to a time to trigger corresponding to the first combination event, add the third cell to a cell trigger list of the first combination event, report a measurement report, and start a first timer, where the number of cells included in the cell trigger list corresponding to the first combination event is greater than a corresponding cell number threshold; and
during running of the first timer, if the third cell meets an entering condition of a second combination event in the N combination events and duration in which the entering condition is met is greater than or equal to a time to trigger corresponding to the second combination event, add the third cell to a cell trigger list of the second combination event, and no longer report a measurement report if the first combination event and the second combination event correspond to a same cell trigger list, where
duration of the first timer is configured by the network side device or specified in a protocol; and
N is a positive integer greater than 1.

Optionally, the processor 710 is configured to:
in a measurement process, when different cell trigger lists corresponding to different combination events overlap successively and each combination event meets a respective entering condition, if the terminal has reported a measurement report within first duration, no longer report a measurement report, where
the first duration is configured by the network side device or specified in a protocol.

Optionally, the processor 710 is further configured to: [0221]
in a case that a first combination event and a second combination event correspond to a same cell trigger list in a measurement process,
if a fourth cell meets a leaving condition of the first combination event in an ongoing measurement process, remove the fourth cell from a cell trigger list corresponding to the first combination event, report a measurement report, and start a second timer; and
if a fifth cell meets a leaving condition of the second combination event during running of the second timer, remove the fifth cell from a cell trigger list corresponding to the second combination event, and no longer report a measurement report, where
duration of the second timer is configured by the network side device or specified in a protocol, and the fifth cell is the same as or different from the fourth cell.

Optionally, the processor 710 is further configured to:
in a case that a first combination event and a second combination event correspond to a same cell trigger list in a measurement process,
if a fourth cell meets a leaving condition of the first combination event in an ongoing measurement process, remove the fourth cell from a cell trigger list corresponding to the first combination event, and report a measurement report; and
if a fifth cell meets a leaving condition of the second combination event within second duration, remove the fifth cell from a cell trigger list corresponding to the second combination event, and no longer report a measurement report, where
the second duration is configured by the network side device or specified in a protocol, and the fifth cell is the same as or different from the fourth cell.

It can be understood that, for an implementation process of the implementations mentioned in this embodiment, reference may be made to related descriptions of the foregoing method embodiment, and a same or corresponding technical effect is achieved. To avoid repetition, details are not described herein again.

An embodiment of this application further provides a network side device, including a processor and a communication interface. The communication interface is coupled to the processor, and the processor is configured to run a program or an instruction to implement the steps of the method embodiment shown in FIG. 3. This network side device embodiment corresponds to the foregoing method embodiment on the network side device. Each implementation process and implementation of the foregoing method embodiment may be applicable to this network side device embodiment, and a same technical effect can be achieved.

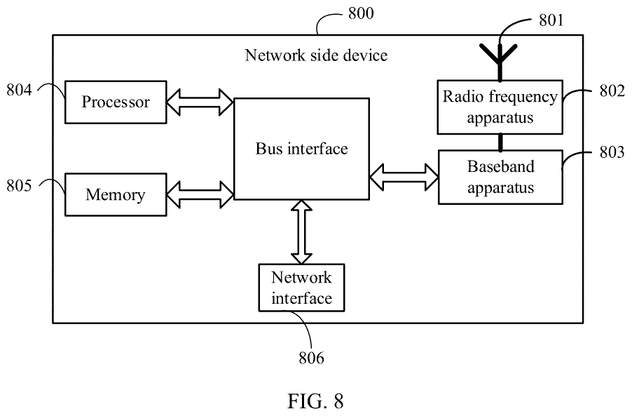

Specifically, an embodiment of this application further provides a network side device. As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information by using the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information by using the antenna 801.

In the foregoing embodiment, the method performed by the network side device may be implemented in the baseband apparatus 803. The baseband apparatus 803 includes a baseband processor.

The baseband apparatus 803 may include, for example, at least one baseband board, where a plurality of chips are disposed on the baseband board. As shown in FIG. 8, one chip, for example, the baseband processor, is connected to the memory 805 through a bus interface, to invoke a program in the memory 805 to perform the operations of the network device shown in the foregoing method embodiment.

The network side device may further include a network interface 806, and the interface is, for example, a common public radio interface (Common Public Radio Interface, CPRI).

Specifically, the network side device 800 in this embodiment of this application further includes an instruction or a program that is stored in the memory 805 and that can be run on the processor 804. The processor 804 invokes the instruction or the program in the memory 805 to perform the method shown in FIG. 3, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing combination event configuration method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or an instruction to implement the processes of the foregoing combination event configuration method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing combination event configuration method embodiment, and a same technical effect can be achieved. To avoid repetition, details are not described herein again.

An embodiment of this application further provides a communication system, including a terminal and a network side device. The terminal may be configured to perform the steps of the foregoing combination event configuration method, and the network side device may be configured to perform the steps of the foregoing combination event configuration method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the foregoing method embodiment may be implemented by computer software product in addition to a necessary general hardware platform or by hardware. The computer software product is stored in a storage medium (for example, a ROM, a RAM, a magnetic disk, or an optical disc) and includes several instructions, so that the terminal or the network side device executes the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms of implementations without departing from the purpose of this application and the protection scope of the claims, all of which fall within the protection of this application.

1. A combination event configuration method, comprising:
receiving, by a terminal, first configuration information sent by a network side device, wherein the first configuration information is used to indicate a configuration of a combination event by the network side device; and
performing, by the terminal, measurement, and determining, based on the first configuration information and whether an entering condition or a leaving condition of the combination event is met in a measurement process, whether to perform measurement reporting, wherein
the combination event is an event formed by combining a first event and a second event, the first event is a terminal height-dependent event, and the second event is a mobility management-dependent event.

2. The combination event configuration method according to claim 1, wherein the first configuration information comprises at least one of the following:
type information of at least one combination event; or
a cell number threshold triggering measurement reporting and corresponding to the combination event.

3. The combination event configuration method according to claim 2, wherein for each combination event, type information of the combination event comprises at least one of the following:
a hysteresis factor, comprising a hysteresis factor of the first event and a hysteresis factor of the second event;
a threshold, comprising a threshold of the first event and a threshold of the second event;
a time to trigger, wherein the time to trigger is used to indicate to trigger measurement reporting in a case that the entering condition of the combination event is met and duration is greater than or equal to the time to trigger; or
a value of reportOnLeave, wherein the value of reportOnLeave is used to indicate whether to initialize a measurement reporting procedure when the leaving condition of the combination event is met.

4. The combination event configuration method according to claim 1, wherein the entering condition of the combination event being met comprises: an entering condition of the first event and an entering condition of the second event are both met.

5. The combination event configuration method according to claim 1, wherein the leaving condition of the combination event being met comprises at least one of the following:
a leaving condition of the first event and a leaving condition of the second event are both met;
a leaving condition of any event among the first event and the second event is met; or
a leaving condition of a first specified event among the first event and the second event is met, wherein
the first specified event is configured by the network side device or specified in a protocol.

6. The combination event configuration method according to claim 3, wherein that the time to trigger is used to indicate to trigger measurement reporting in a case that the entering condition is met and the duration is greater than or equal to the time to trigger comprises at least one of the following:
after an entering condition of the first event and an entering condition of the second event are both met, if the entering condition of the first event and the entering condition of the second event are always met within the time to trigger, triggering measurement reporting or adding a first cell to a cell trigger list corresponding to the combination event, wherein the first cell is a neighboring cell that meets the entering condition of the first event and the entering condition of the second event;
after an entering condition of the first event and an entering condition of the second event are both met, if an entering condition of any event among the first event and the second event is always met within the time to trigger, triggering measurement reporting or adding a first cell to a cell trigger list corresponding to the combination event, wherein the first cell is a neighboring cell that meets the entering condition of any event among the first event and the second event; or
after an entering condition of the first event and an entering condition of the second event are both met, if an entering condition of a second specified event among the first event and the second event is always met within the time to trigger, triggering measurement reporting or adding a first cell to a cell trigger list corresponding to the combination event, wherein the first cell is a neighboring cell that meets the entering condition of the second specified event, wherein
the second specified event is configured by the network side device or specified in a protocol.

7. The combination event configuration method according to claim 3, wherein the time to trigger is a plurality of times to trigger separately configured for the first event and the second event or one time to trigger configured for the combination event.

8. The combination event configuration method according to claim 3, wherein in a case that the value of reportOnLeave is True, the terminal performs at least one of the following:
reporting a measurement report and removing a second cell from a cell trigger list corresponding to the combination event when a leaving condition of any event among the first event and the second event is met, wherein the second cell is a neighboring cell that meets the leaving condition of any event among the first event and the second event;
reporting a measurement report and removing a second cell from a cell trigger list corresponding to the combination event when a leaving condition of the first event and a leaving condition of the second event are both met, wherein the second cell is a neighboring cell that meets the leaving condition of the first event and the leaving condition of the second event;
reporting a measurement report and removing a second cell from a cell trigger list corresponding to the combination event when a leaving condition of a third specified event among the first event and the second event is met, wherein the second cell is a neighboring cell that meets the leaving condition of the third specified event, and the third specified event is configured by the network side device or specified in a protocol; or
deleting a cell trigger list corresponding to the combination event when a leaving condition of the first event is met.

9. The combination event configuration method according to claim 6, wherein the terminal performs measurement reporting in a case that the number of cells in the cell trigger list is greater than or equal to the cell number threshold corresponding to the combination event.

10. The combination event configuration method according to claim 1, wherein the determining, based on the first configuration information and whether an entering condition or a leaving condition of the combination event is met in a measurement process, whether to perform measurement reporting comprises:
if the terminal determines that cell trigger lists corresponding to N combination events are totally the same or all comprise a same cell, and the number of cells comprised in a cell trigger list corresponding to each of the N combination events is greater than a cell number threshold corresponding to each of the N combination events, reporting, by the terminal, a measurement report only once, wherein
the measurement report reported by the terminal is a measurement report corresponding to any one of the N combination events or a measurement report reported based on an instruction of the network side device; and
N is a positive integer greater than 1.

11. The combination event configuration method according to claim 1, further comprising:
in a measurement process of the terminal, if a same cell or different cells simultaneously meet a leaving condition in overlapping cell trigger lists corresponding to different measurement identities, removing the cell that meets the leaving condition from a corresponding cell trigger list, and reporting a measurement report once, wherein
the measurement report reported by the terminal is a measurement report corresponding to any one of the measurement identities or a measurement report reported based on an instruction of the network side device; and
N is a positive integer greater than 1.

12. The combination event configuration method according to claim 1, wherein the determining, based on the first configuration information and whether an entering condition or a leaving condition of the combination event is met in a measurement process, whether to perform measurement reporting comprises:
in a measurement process, if a third cell meets an entering condition of a first combination event in N combination events and duration in which the entering condition is met is greater than or equal to a time to trigger corresponding to the first combination event, adding the third cell to a cell trigger list of the first combination event, and if the number of cells comprised in the cell trigger list corresponding to the first combination event is greater than a corresponding cell number threshold, reporting, by the terminal, a measurement report and starting a first timer; and
during running of the first timer, if the third cell meets an entering condition of a second combination event in the N combination events and duration in which the entering condition is met is greater than or equal to a time to trigger corresponding to the second combination event, adding the third cell to a cell trigger list of the second combination event, and if the first combination event and the second combination event correspond to a same cell trigger list, no longer reporting, by the terminal, a measurement report, wherein
duration of the first timer is configured by the network side device or specified in a protocol; and
N is a positive integer greater than 1.

13. The combination event configuration method according to claim 1, wherein the determining, based on the first configuration information and whether an entering condition or a leaving condition of the combination event is met in a measurement process, whether to perform measurement reporting comprises:
in a measurement process, when different cell trigger lists corresponding to different combination events overlap successively and each combination event meets a respective entering condition, if the terminal has reported a measurement report within first duration, no longer reporting, by the terminal, a measurement report, wherein
the first duration is configured by the network side device or specified in a protocol.

14. The combination event configuration method according to claim 1, further comprising:
in a case that a first combination event and a second combination event correspond to a same cell trigger list in a measurement process of the terminal,
if a fourth cell meets a leaving condition of the first combination event in an ongoing measurement process of the terminal, removing, by the terminal, the fourth cell from a cell trigger list corresponding to the first combination event, reporting a measurement report, and starting a second timer; and
if a fifth cell meets a leaving condition of the second combination event during running of the second timer, removing, by the terminal, the fifth cell from a cell trigger list corresponding to the second combination event, and no longer reporting a measurement report, wherein
duration of the second timer is configured by the network side device or specified in a protocol, and the fifth cell is the same as or different from the fourth cell.

15. A combination event configuration method, comprising:
sending, by a network side device, first configuration information to a terminal, wherein the first configuration information is used to indicate a configuration of a combination event by the network side device; and
the combination event is an event formed by combining a first event and a second event, the first event is a terminal height-dependent event, and the second event is a mobility management-dependent event.

16. The combination event configuration method according to claim 15, wherein the first configuration information comprises at least one of the following:
type information of at least one combination event; or
a cell number threshold triggering measurement reporting and corresponding to each combination event.

17. The combination event configuration method according to claim 16, wherein for each combination event, type information of the combination event comprises at least one of the following:
a hysteresis factor, comprising a hysteresis factor of the first event and a hysteresis factor of the second event;
a threshold, comprising a threshold of the first event and a threshold of the second event;
a time to trigger, wherein the time to trigger is used to indicate to trigger measurement reporting in a case that an entering condition of the combination event is met and duration is greater than or equal to the time to trigger; or
a value of reportOnLeave, wherein the value of reportOnLeave is used to indicate whether to initialize a measurement reporting procedure when a leaving condition of the combination event is met.

18. A terminal, comprising a processor and a memory, wherein the memory stores a program or an instruction that can be run on the processor, and the program or the instruction is executed by the processor to implement a combination event configuration method, the combination event configuration method comprises:
receiving first configuration information sent by a network side device, wherein the first configuration information is used to indicate a configuration of a combination event by the network side device; and
performing measurement, and determining, based on the first configuration information and whether an entering condition or a leaving condition of the combination event is met in a measurement process, whether to perform measurement reporting, wherein
the combination event is an event formed by combining a first event and a second event, the first event is a terminal height-dependent event, and the second event is a mobility management-dependent event.

19. A network side device, comprising a processor and a memory, wherein the memory stores a program or an instruction that can be run on the processor, and the program or the instruction is executed by the processor to implement the combination event configuration method according to claim 15.

20. A non-transitory readable storage medium, wherein the readable storage medium stores a program or an instruction, and the program or the instruction is executed by a processor to implement the combination event configuration method according to claim 1.
